(19) United States
(12) Patent Application Publication
(10) Pub. No.: US 2009/0134813 A1
(43) Pub. Date: May 28, 2009

(54) DISCHARGE LAMP LIGHTING DEVICE

(75) Inventors: Noriyuki Kitamura, Hadano-shi (JP); Hajime Osaki, Yokosuka-shi (JP); Naoko Iwai, Yokohama-shi (JP); Toru Ishikita, Yokosuka-shi (JP); Masahiko Kamata, Yokohama-shi (JP)

Correspondence Address: DARBY & DARBY P.C., P.O. BOX 770, Church Street Station, New York, NY, 10008-0770, US

(73) Assignee: Toshiba Lighting & Technology Corporation, Tokyo (JP)

(21) Appl. No.: 12/323,631

(22) Filed: Nov. 26, 2008

(30) Foreign Application Priority Data
Nov. 28, 2007 (JP) 2007-307831
May 28, 2008 (JP) 2008-140090

(51) Int. Cl. H05B 41/36

(52) U.S. Cl. 315/291

(57) ABSTRACT

The inverter circuit is feedback-controlled by a substantial current flowing into the discharge lamp, which is detected by the current detecting means. A high starting voltage is supplied to the discharge lamp with the operation frequency lowered by the control circuit after the end of a preheating action. The inverter circuit is controlled so that the current of the discharge lamp becomes a desired current value as soon as the current detecting means detects the current substantially flowing into the discharge lamp. The discharge lamp can be prevented from being instantaneously brightly lit without separately providing any structure for detecting lighting of the discharge lamp.

### INCORPORATION BY REFERENCE

The present invention claims priority under 35 U.S.C. §119 to Japanese Patent Application No. 2007-307831 filed on Nov. 28, 2007 and Japanese Patent Application No. 2008-140090 filed on May 28, 2008. The content of the application is incorporated herein by reference in their entirety.

### FIELD OF THE INVENTION

The present invention relates to a discharge lamp lighting device for lighting a discharge lamp.

### BACKGROUND OF THE INVENTION

Conventionally, for example, a half-bridge type inverter circuit has been used in a discharge lamp lighting device. An LC resonance circuit including an inductor and a capacitor is connected between outputs of the inverter circuit, and the discharge lamp is started and lit by a resonance action of the LC resonance circuit.

Also, where the device is provided with a function for modulating the light of the discharge lamp, the discharge voltage of the discharge lamp and the current output by the inverter circuit are detected in order to stably modulate the light of the discharge lamp particularly when meticulously modulating the light, and the inverter circuit is feedback-controlled using the detected voltage and output current.

Where such a discharge lamp lighting device is used in an area where the operation frequency is greater than the resonance frequency when the resonance circuit is not loaded, the device is controlled so that, when starting the discharge lamp, the operation frequency is returned to a predetermined frequency after the high-frequency voltage output from the inverter circuit is increased to a predetermined starting voltage with the operation frequency once lowered and the discharge lamp is lit.

In the control, as described in, for example, Japanese Laid-Open Patent Publication No. 2006-210267, a threshold voltage preset in the vicinity of the starting voltage is compared with the discharge voltage of the discharge lamp, which is detected in a starting operation, controlling means determines that, when the discharge voltage exceeds the threshold voltage, the discharge lamp is lit.

However, since the above-described discharge lamp lighting device requires lighting detecting means for detecting lighting of a discharge lamp by comparing the discharge voltage of the discharge lamp with a threshold voltage, there is a problem that the structure is complicated.

In addition, since it is not necessarily possible to detect the moment when the discharge voltage exceeds the threshold voltage when comparing the discharge voltage of a discharge lamp with the threshold voltage, there is another problem that since the lamp current or the lamp power is instantaneously increased, the discharge lamp is instantaneously subjected to being brightly lit when the discharge lamp is started.

The present invention has been developed in view of these points, and it is therefore an object of the present invention to provide a discharge lamp lighting device capable of preventing the discharge lamp from being instantaneously brightly lit when the discharge lamp is started, without becoming complicated in structure.

### SUMMARY OF THE INVENTION

A discharge lamp lighting device according to the present invention includes: an inverter circuit for converting a direct current voltage to a high frequency voltage by operation of a switching element and outputting the same; a resonance circuit having an inductor and a capacitor, which are connected in series between outputs of the inverter circuit and resonating in accordance with the high-frequency voltage; a discharge lamp connected between both ends of the capacitor of the resonance circuit, which is lit by a resonance action of the resonance circuit; current detecting means for detecting a current substantially flowing to the discharge lamp; and controlling means for feedback-controlling the switching element of the inverter circuit based on the current detected by the current detecting means, preheating the discharge lamp at a voltage at which the discharge lamp is not lit when preheating, supplying a higher high-frequency voltage than when preheating to the discharge lamp with the operation frequency lowered when starting at least after termination of a preheating action, and controlling the inverter circuit by the feedback control once every predetermined short cycle so that the current of the discharge lamp becomes a predetermined current value when the current detecting means detects the current substantially flowing to the discharge lamp.

For example, a hot cathode type fluorescent lamp and a high-voltage discharge lamp are available as the discharge lamp, but the discharge lamp is not limited thereto.

For example, either a half-bridge type or a full-bridge type may be available as the inverter circuit as long as it can convert a direct current voltage to a high-frequency voltage by operation of a switching element such as an electric-field effect transistor, etc., and can output the same.

The “current substantially flowing to a discharge lamp” means, for example, a current flowing into a discharge lamp other than a leakage current flowing in a capacitance component.

“Detecting a current substantially flowing to a discharge lamp by means of current detecting means” means timing when a starting voltage of a discharge lamp is reached, whereby by instantaneously making the current of a discharge lamp into a predetermined current value when the starting voltage of the discharge lamp is reached, lighting of the discharge lamp can be started even from a low light modulation ratio to such a degree that human eyes do not sense flash.

“Predetermined short cycle” means, for example, cycles such as every cycle in which the current detecting means detects a current.

And, the inverter circuit can be accurately feedback-controlled by feed-back controlling the switching element of the inverter circuit by a current detected by the current detecting means at the peak phase of the voltage of a discharge lamp, and a relatively higher high-frequency voltage than when preheating is supplied to the discharge lamp with the operation frequency lowered at least after termination of the preheating action by the controlling means, and the inverter circuit is feedback-controlled once every predetermined short cycle so that the current of the discharge lamp becomes a predetermined current value when the current detecting means detects the current substantially flowing to the discharge lamp, whereby it is possible to prevent the discharge lamp from instantaneously brightly being lit without separately incorporating a structure which detects lighting of the discharge lamp.

Further, in the present invention, feedback control of the switching element of the inverter circuit by the controlling means is carried out in a predetermined short-time cycle in the process at least from termination of preheating action to desired lighting of a discharge lamp, which includes the starting time thereof, and the target value of current after termination of the preheating action is gradually increased, wherein a desired lighting state is brought about by gradually increasing the light quantity of the discharge lamp.

And, by carrying out the feedback control of the switching element of the inverter circuit by the controlling means in a predetermined short-time cycle in the process at least from termination of preheating action to desired lighting of a discharge lamp, which includes the starting time thereof, the responsiveness of the feedback control can be further improved, and by gradually increasing the target value of current after termination of the preheating action to gradually increase the light quantity of the discharge lamp, a desired lighting state is brought about, and it is possible to light and start the discharge lamp without instantaneously becoming bright until a desired lighting state is reached.

In addition, in the present invention, feedback control of the switching element of the inverter circuit by the controlling means is carried out in every cycle.

And, by carrying out the feedback control of the switching element of the inverter circuit by the controlling means in every cycle, the responsiveness of the feedback control can be further improved, and it is possible to light and start the discharge lamp without instantaneously becoming bright.

Also, in the present invention, when a discharge lamp is mounted, the controlling means starts the discharge lamp.

And, since the controlling means starts a discharge lamp when it is mounted, it is possible to gradually light and start the discharge lamp when it is mounted.

Further, in the present invention, the controlling means starts a discharge lamp when a light modulation signal is input by peripheral operation when the discharge lamp is in an unlit state.

“Peripheral operation” means, for example, operation of light modulation operating means such as a remote controller for light modulation.

And, by starting the discharge lamp when a light modulation signal is input by a peripheral operation in an unlit state of the discharge lamp, it is possible to gradually light and start the discharge lamp in association with the peripheral operation.

Also, in the present invention, the controlling means varies the tracking of light quantity of the discharge lamp in accordance with a fluctuation amount of the light modulation signal input by a peripheral operation.

Further, by varying the tracking of the light quantity of the discharge lamp in accordance with the fluctuation amount of the light modulation signal input by a peripheral operation, light modulation for which human eyes are less susceptible to a sense of discomfort can be carried out.

Still further, in the present invention, the controlling means causes the current of the discharge lamp to track up to the target value at a value corresponding to the fluctuation amount where the fluctuation amount of a light modulation signal input by peripheral operation is less than a predetermined value, and causes the current of the discharge lamp to track up to the target value at a predetermined upper limit value where the fluctuation amount of a light modulation signal input by peripheral operation is a predetermined value or more.

And, since the current of the discharge lamp is caused to track up to the target value at a value corresponding to the quantity of change where the fluctuation amount of a light modulation signal input by peripheral operation is less than a predetermined value, and the current of the discharge lamp is caused to track up to the target value at a predetermined upper limit value where the fluctuation amount of a light modulation signal input by peripheral operation is a predetermined value or more, the light modulation signal is set so that the tracking of the light quantity of the discharge lamp is not too slow or too fast.

In addition, in the present invention, the inverter circuit is a half-bridge type inverter circuit.

And, by adopting a half-bridge type inverter circuit as the inverter circuit, feedback control by the controlling means is facilitated.

Further, in the present invention, the discharge lamp is a fluorescent lamp.

And, since the discharge lamp is a fluorescent lamp, it is possible to provide a fluorescent lamp that can be lit and started without being instantaneously brightly lit when it is started.

### BRIEF DESCRIPTION OF THE DRAWINGS

FIG. 1 is a circuit diagram of a discharge lamp lighting device according to one embodiment of the present invention, FIG. 2 is a waveform diagram showing the relationship among discharge voltage, discharge current and leakage current of the discharge lamp lighting device, FIG. 3 shows a detection method for detecting the peak phase of the discharge voltage in the discharge lamp lighting device, wherein (a) is a waveform diagram showing the discharge voltage and discharge current, and (b) is a waveform diagram obtained by sampling the discharge voltage and discharge current, FIG. 4 shows a detection method, wherein (a) is a waveform diagram showing the discharge voltage and discharge current, and (b) is a waveform diagram obtained by sampling the discharge voltage and discharge current, FIG. 5 is a waveform diagram showing the relationship among discharge voltage, detecting voltage and leakage current components of the discharge lamp lighting device, FIG. 6 is a perspective view of an illumination device to which the discharge lamp lighting device is applied, FIG. 7 is a graph showing the relationship between the frequency of the discharge lamp lighting device and the output voltage and discharge voltage at the second side of a resonance circuit, and FIG. 8 is a wave form diagram showing the relationship among the discharge voltage of the discharge lamp lighting device, the output current thereof and the light quantity of the discharge lamp, wherein (a) is a waveform diagram showing an envelope of the discharge voltage, (b) is a waveform diagram of an envelope of the output current, and (c) is a waveform diagram of an envelope of the light quantity of the discharge lamp.

### DETAILED DESCRIPTION OF THE PREFERRED EMBODIMENT

Hereinafter, a description is given of one embodiment of the present invention with reference to FIG. 1 through FIG. 8.

FIG. 1 is a circuit diagram showing a discharge lamp lighting device, FIG. 2 is a waveform diagram showing the relationship among discharge voltage, discharge current and leakage current of the discharge lamp lighting device, FIG. 3 shows a detection method for detecting the peak phase of the discharge voltage in the discharge lamp lighting device, wherein (a) is a waveform diagram showing the discharge voltage and discharge current, and (b) is a waveform diagram obtained by sampling the discharge voltage and discharge current, FIG. 4 shows a detection method, wherein (a) is a waveform diagram showing the discharge voltage and discharge current, and (b) is a waveform diagram obtained by sampling the discharge voltage and discharge current, FIG. 5 is a waveform diagram showing the relationship among discharge voltage, detecting voltage and leakage current components of the discharge lamp lighting device, FIG. 6 is a perspective view of an illumination device to which the discharge lamp lighting device is applied, FIG. 7 is a graph showing the relationship between the frequency of the discharge lamp lighting device and the output voltage and discharge voltage at the second side of a resonance circuit, and FIG. 8 is a waveform diagram showing the relationship among the discharge voltage of the discharge lamp lighting device, the output current thereof and the light quantity of the discharge lamp, wherein (a) is a waveform diagram showing an envelope of the discharge voltage, (b) is a waveform diagram of an envelope of the output current, and (c) is a waveform diagram of an envelope of the light quantity of the discharge lamp.

As shown in FIG. 1, in a discharge lamp lighting device 10, the input terminal of a full-wave rectification element REC for rectifying the commercial power voltage is connected to the commercial power source “e”, and a voltage boosting circuit 11 that boosts the rectified direct current voltage is connected to the output terminal of the full-wave rectification element REC. A smoothening capacitor C1 is connected between the output terminals of the voltage boosting circuit 11, and an inverter circuit 12 that converts the direct current voltage to high-frequency voltage and outputs the same is connected therebetween. The inverter circuit 12 is a half-bridge type inverter, which has electric-field effect transistors Q1 and Q2 operating as two switching elements connected in series. A capacitor (not illustrated) for cutting direct current and a resonance circuit 13 including a resonance inductance L being an inductor and a resonance capacitor C2 being a capacitor are connected to both ends of the electric field effect transistor Q2. A discharge lamp FL, for example, a hot cathode type fluorescent lamp is connected in parallel to the resonance capacitor C2. Also, means for heating filaments of the discharge lamp FL is omitted in the drawings.

In addition, a control circuit 16 operating as controlling means that controls turning-on and turning-off actions of the electric field effect transistors Q1 and Q2 is connected to the gates of the electric field effect transistors Q1 and Q2.

Further, a voltage dividing circuit 19 that is composed of a pair of resistors R1 and R2 is connected to both ends of the resonance capacitor C2, and voltage detecting means 20 that detects the voltage of the discharge lamp FL is composed by the voltage dividing circuit 19.

Still further, a series circuit with an anti-blocking diode D1 and a resistor R3 is connected between one filament of the discharge lamp FL and one end side at which the resonance capacitor C2 is grounded, and a diode D2 is connected between the anode side of the diode D1 and the grounding side of the resistor R3. Current detecting means 24 is thus composed, which detects a substantial current flowing to the discharge lamp FL at the connection point 23 of the diode D1 and the resistor R3, that is, a current (hereinafter called output current) flowing into the discharge lamp FL excluding the leakage current flowing to capacitance components, etc.

The voltage detecting means 20 and the current detecting means 24 are connected to the detection circuit 27. The detection circuit 27 includes a function of peak phase detecting means for detecting the peak phase of the voltage that the voltage detecting means 20 detects, and a function of correcting means for correcting delay of the phase of voltage detected by the voltage detecting means 20 to the phase of the discharge voltage of the discharge lamp FL. Also, the peak phase detecting means and the correcting means may be provided in the control circuit 16. Here, the peak phase of the discharge voltage expresses the maximum value or the minimum value of the discharge voltage of a sinusoidal wave.

During a starting period until the discharge lamp FL is lit, the correcting means attains a correction amount for correcting the delay in peak phase of voltage detected by the peak phase detecting means with respect to the peak phase of voltage corresponding to a rough zero cross of a waveform of the capacitance component detected by the current detecting means 24, for example, the leakage current component, and corrects the delay in phase of the voltage detected by the voltage detecting means 20 by the correction amount after the discharge lamp FL is lit.

And, the control circuit 16 is provided with a microprocessor, memory, VCO (voltage control oscillator), etc., (these are not illustrated), which are control elements such as, a microcomputer and DSP (digital signal processor), and includes a function of feedback-controlling the inverter circuit 12 so that the output current (discharge current) of the inverter circuit 12, which is detected by the current detecting means 24, is approached as predetermined target value at the peak phase of voltage detected by the peak phase detecting means and corrected by the correcting means and a function of controlling the light-modulating level based on the target value set corresponding to a light modulation signal input by a peripheral operation of light modulation operating means such as a remote controller (not illustrated).

As shown in FIG. 2, since the leakage current component I_C is capacitive at the position of the peak phase of the discharge voltage VL, it can be considered that the leakage current component I_C is zero. Therefore, only the discharge current IL is detected. Since the output current is the sum of the discharge current IL and the leakage current component I_C, and the leakage current component I_C is zero at the position of the peak phase of the discharge voltage VL, it is possible to detect only the discharge current IL with a simple structure by detecting the output current at the peak phase of the discharge voltage VL, wherein the electric field effect transistors Q1 and Q2 of the inverter circuit 12 can be feedback-controlled by the discharge current IL, and stabilized lighting can be attained in meticulous light modulation. In the present embodiment, it is assumed that the feedback control is carried out, for example, in every cycle.

Next, a description is given of a detection method for detecting the peak phase of the discharge voltage by the peak phase detecting means with reference to FIG. 3 and FIG. 4.

Detection values of the discharge voltage and output current are analog signals. Values can be obtained at respective sampling points by providing sampling means for sampling analog signals of the discharge voltage and output current discretely with regard to time in the detection circuit 27 (or the control circuit 16) shown in FIG. 1. As such sampling means, means composed of a sample/hold circuit and an A/D (analog/digital) converter has been widely used. By the means, as analog signals of the discharge voltage and output current are detected, it is possible to digitize the sampling values discretely with regard to time. That is, the analog signals can be varied to a mode, which can be numerically calculated, by calculating means such as a CPU.

FIG. 3(a) and FIG. 3(b) are conceptual views in the case where analog signals of the discharge voltage are sampled. Briefly described, it is composed that the objects are made into the discharge voltage VL and the discharge current IL, and negative potential is not brought about under an optional offset. If respective analog signals pass through the sample/hold circuit and the A/D converter, the analog signals can be converted to a discrete amount obtained by sampling the analog signals at a set sampling cycle Ts. At this time, the signals of the discharge voltage VL and the discharge current IL can be, respectively, expressed as an aggregate of discrete amounts of {v[0], v[1], v[2], . . .}, {i[0], i[1], i[2], . . .}. Since respective values are digitized, the respective values may be subject to comparison calculations and arithmetical operations. If it is assumed that the frequency of signals to be sampled is theoretically “f signal,” the original signals can be reproduced from the discrete amount if the sampling frequency fs(=1/Ts) is of the relationship of fs>2×f signal based on the sampling theorem, wherein the original detection signals can be reproduced by giving optional interpolation thereto.

Herein, in order to know the peak phase of the discharge voltage VL, the discrete values are utilized as shown in FIG. 3(b). If values sampled as shown in FIG. 3(b) are sequentially compared with each other, the relationship thereof is v[0]<v[1]<v[2]<v[3]>v[4]>v[5]. Using this, it is found that v[3] is the peak phase of the discharge voltage VL. Therefore, it is understood that i[3] of the discharge current IL, which corresponds to v[3] of the peak phase of the discharge voltage VL gives a discharge current IL synchronized with the peak phase of the discharge voltage VL. Thus, the peak phase of the discharge voltage VL is detected by discretely sampling the analog signals of the discharge voltage VL, and the output current is detected in synchronization with the peak phase of the discharge voltage VL, wherein it is possible to easily detect only the discharge current IL excluding the leakage current component I_C.

In addition, FIG. 4 shows a condition of detecting the discharge current IL in an actual circuit configuration. FIG. 4(a) shows a waveform of the input into the sample/hold circuit of discharge voltage VL and output currents of the inverter circuit 12. FIG. 4(b) shows sampling results via the A/D converter. And, the detected discharge voltage VL and output current of the inverter circuit 12 are input into the sample/hold circuit as rectified waveforms. Also, when modulating light, the output current is brought into an advanced phase with respect to the waveform of the discharge voltage VL as shown in FIG. 4. At this time, v[0]<v[1]<v[2]<v[3]>v[4] is indexed by using the calculating means, and it can be known that the phase v[3] is the peak phase of the discharge voltage VL. i[3] being the value of the output current of the inverter circuit 12 in the phase information corresponds to the peak phase of the discharge current IL.

Herein, it is constructed that, by simultaneously and independently sampling the discharge voltage VL and the output current of the inverter circuit 12, no difference is brought about between the peak phase of the discharge voltage VL and the peak phase of the discharge current IL. Although it is preferable that, as a circuit configuration, a sample/hold circuit and an A/D converter are provided independently with respect to the respective detection amounts, roughly simultaneous sampling can be carried out if determination of the peak phase of the discharge voltage VL, acquisition of the phase information and detection of the peak phase of the discharge current IL are repeated by a single circuit equipped with a sample/hold circuit and an A/D converter.

In addition, if a sample/hold circuit and an A/D converter are internally incorporated in a microprocessor, the circuit configuration can be simplified.

Next, FIG. 5 shows an example for correcting a delay in phase of voltage, which is detected by the voltage detecting means 20, with respect to the phase of discharge voltage of the discharge lamp FL by the correcting means.

Since the inverter circuit 12 oscillates although no discharge current flows to the discharge lamp FL during a starting period from input of power voltage to lighting of the discharge lamp FL, a high frequency high voltage is output from the resonance circuit 13 to the discharge lamp FL. At this time, a leakage current flows to the electrostatic capacitance generated between the discharge lamp FL and the device, and the delay is corrected by using the leakage current component.

FIG. 5 shows the discharge voltage VL, the detection voltage VL_det detected by the voltage detecting means 20 and the leakage current component I_C during a starting period, respectively. If the peak phase is detected or calculated on the basis of the detection current VL_det, a peak phase VL_det peak 1 is obtained. On the contrary, if the peak phase of the detection voltage VL_det is corrected before starting so that the leakage current component I_C becomes zero, a peak phase VL_det peak 2 is obtained. Therefore, a correction amount from the peak phase VL_det peak 1 to the peak phase VL_det peak 2 can be obtained.

A discharge lamp lighting device 10 thus constructed can be applied to an illumination device as shown in FIG. 6. The illumination device is provided with a device main body 41 having the discharge lamp lighting device 10 disposed therein and sockets 42 between which a tubular discharge lamp FL is mounted at both ends of the device main body 41, etc.

Next, a description is given of actions of the embodiment described above with reference to FIG. 7 and FIG. 8.

For example, when starting by means of peripheral operation of light modulation operating means or when the discharge lamp FL is mounted in the device main body 41, the voltage boosting circuit 11 is driven by the commercial power source “e,” and the control circuit 16 is driven, wherein the electric field effect transistors Q1 and Q2 is subjected to switching operation, and high frequency voltage is output from the inverter circuit 12.

The control circuit 16 first carries out a preheating action. That is, a frequency signal of higher frequency f1 than the load-free resonance frequency f0 of the resonance circuit 13 is generated by supplying a predetermined voltage level to VCO, the control circuit 16 causes the electric field effect transistors Q1 and Q2 to be driven for switching in accordance with the frequency signal, and the high frequency voltage V1 for preheating is supplied to the discharge lamp FL.

As a result, a preheating current is caused to flow to the filaments of the discharge lamp FL by the high frequency voltage V1, and preheating is carried out for a predetermined period of time.

As the preheating action is terminated, the control circuit 16 actuates the VCO by the voltage signal level from the voltage detecting means 20, and the VCO outputs a frequency signal responsive to the voltage signal level. Therefore, the VCO lowers the frequency of the frequency signal to be output to the vicinity of the resonance frequency f0 of the resonance circuit 13. For this reason, the operation frequency of the inverter circuit 12 is raised to the frequency fs, the high frequency voltage applied to the discharge lamp FL is increased by preheating in line therewith, and becomes the starting voltage Vs of the discharge lamp FL, wherein the discharge lamp FL is lit.

At this time, since the detection circuit 27 detects the output current of the discharge lamp FL at a timing of the peak phase of corrected discharge voltage VL not including the leakage current component I_C, it detects only the discharge current IL. Therefore, the timing at which the discharge current IL is detected by the current detection means 24 connected to the detection circuit 27 becomes the timing at which the high frequency voltage became the starting voltage Vs, that is, the timing at which the discharge lamp FL is lit. Therefore, by the control circuit 16 supplying the above-described predetermined voltage level, which is relatively high, to the VCO at the timing, the operation frequency of the inverter circuit 12 is increased to frequency f1 by the frequency signal of higher frequency, which is output from the VCO, and the output high frequency voltage is lowered to a predetermined high frequency voltage V1. That is, since the timing at which the discharge current IL is detected by the current detecting means 24 is roughly in agreement with the timing at which the discharge lamp FL is lit, the current of the discharge lamp FL can instantaneously be set to a desired relatively lower current value when the discharge current IL is detected by the current detecting means 24.

Simultaneously, the control circuit 16 gradually increases the target value of the discharge current IL to cause the discharge lamp FL to be lit to fade in. Here, where the fluctuation amount of a light modulation signal, which is set by peripheral operation of the light modulation operating means, is less than a predetermined value set in advance, the discharge current IL is caused to track up to the target value at a value corresponding to the fluctuation amount, and where the fluctuation amount of the light modulation signal is a predetermined value set in advance or more, the discharge current IL is caused to track up to the target value at a predetermined upper limit value.

FIG. 8 shows the discharge voltage VL of the discharge lamp FL, the output current thereof and a condition of light quantity from preheating to starting of lighting. FIG. 8(a) shows the discharge voltage VL, FIG. 8(b) shows the output current including the leakage current I_C, and FIG. 8(c) shows the light quantity of the discharge lamp FL, which is detected by, for example, a photodiode, etc. The discharge lamp FL is preheated in the term T1, and the discharge lamp FL is lit at timing T2. At this time, the overshoot of the discharge current IL became 10% or less (almost zero) of the target value, and the discharge current IL became the target value within 1 msec. Also, when starting, the brightness of the discharge lamp FL was instantaneously 5% or less.

After that, the inverter circuit 12 supplies high frequency voltage V1 to the discharge lamp FL so that the discharge lamp FL maintains a predetermined discharge voltage VL.

In addition, after the discharge lamp FL is lit, the delay in the phase of voltage detected by the voltage detecting means 20 can be corrected by the correction amount obtained during the starting period.

Thus, according to the above-described embodiment, by feedback-controlling the electric field effect transistors Q1 and Q2 of the inverter circuit 12 by the current detected by the current detecting means 24, the inverter circuit 12 is accurately feedback-controlled by the discharge current of the discharge lamp FL, the operation frequency is lowered by the control circuit 16 at least after the end of preheating action, the starting voltage Vs being a high-frequency voltage, which is relatively higher than when preheating, is supplied to the discharge lamp FL, and the discharge current IL of the discharge lamp FL is detected by the current detecting means 27, wherein since the inverter circuit 12 can be controlled so that the current of the discharge lamp FL instantaneously becomes a desired current value, it is possible to accurately detect the timing of lighting of the discharge lamp FL without separately providing such a structure for detecting the lighting of the discharge lamp FL. As a result, the discharge lamp FL can be gradually lit and started just like an electric bulb without being instantaneously brightly lit, and the discharge lamp FL can be lit and started to such a degree that human eyes do not sense any flash, even from a low light modulation ratio.

Further, if feedback control of the electric field effect transistors Q1 and Q2 of the inverter circuit 12 is carried out by the control circuit 16 in a predetermined short cycle in the process at least from the end of preheating action to desired lighting of the discharge lamp including the time of starting, for example, once every cycle of detecting the current of the current direction means 27, the responsiveness of the feedback control can be further improved, wherein it is possible to light and start the discharge lamp FL without being instantaneously brightly lit.

Still further, if the light quantity of the discharge lamp FL is gradually increased by gradually increasing the target value of the output current after the end of preheating action of the discharge lamp FL, even the discharge lamp FL can be lit to fade in without being instantaneously brightly lit until reaching a predetermined lighting state.

And, by starting the discharge lamp FL when mounting the discharge lamp FL or when a light modulation signal is input by peripheral operation by light modulation operating means such as, for example, a remote controller, etc., in an unlit state of the discharge lamp FL, it is possible to gradually light and start the discharge lamp FL when mounting the discharge lamp FL or in association with the peripheral operation.

Further, where the light quantity of the discharge lamp FL is caused to track the fluctuation amount of the light modulation signal input by peripheral operation of the light modulation operating means as it is, for example, if the fluctuation amount is large, a sense of discomfort is given since a fluctuation in the light quantity of the discharge lamp FL is too fast. However, in the present embodiment, since the tracking of the light quantity of the discharge lamp FL is altered in accordance with the fluctuation amount of the light modulation signal input by peripheral operation of the light modulation operating means, light modulation by which no sense of discomfort is given to human eyes is enabled.

In detail, where the fluctuation amount of the light modulation signal input by peripheral operation of the light modulation operating means is less than a predetermined value, the current of the discharge lamp FL is caused to track up to the target value at a value corresponding to the fluctuation amount, and where the fluctuation amount of the light modulation signal input by peripheral operation of the light modulation operating means is a predetermined value or more, the current of the discharge lamp FL is caused to comparatively slowly track up to the target value at a predetermined upper limit value, wherein the light modulation signal can be set so that the tracking of the light quantity of the discharge lamp FL is not too slow or too fast.

Further, since the inverter circuit 12 can be feedback-controlled by the current detected by the current detecting means 24 at a timing of the peak phase of the discharge voltage of the discharge lamp FL, the inverter circuit 12 can be feedback-controlled even in meticulous light modulation by the discharge current IL from which influences due to delay in the phase of the voltage detected by the voltage detecting means 20 are excluded, and meticulous light modulation can be carried out.

Also, the correcting means may use, for example, a data table in which correction amounts necessary to correct a delay in the phase of voltage detected by the voltage detecting means 20 with respect to the phase of the discharge voltage of the discharge lamp FL, and may correct a delay in the phase of voltage detected by the voltage detecting means 20 based on the correction amounts registered in the data table. In this case, the data table is provided in the detection circuit 27 or the control circuit 16.

In addition, the voltage detecting means and the current detecting means may be optionally constructed. If the delay in phase of voltage detected by the voltage detecting means can be corrected with respect to the peak phase of the discharge voltage VL of the discharge lamp FL in association with the voltage detecting means and the current detecting means, it may be possible that the peak phase detecting means and the correcting means are optionally constructed.

1. A discharge lamp lighting device, comprising:
an inverter circuit for converting a direct current voltage to a high frequency voltage by operation of a switching element and outputting the same;
a resonance circuit having an inductor and a capacitor, which are connected in series between outputs of the inverter circuit and resonating in accordance with the high-frequency voltage;
a discharge lamp connected between both ends of the capacitor of the resonance circuit, which is lit by a resonance action of the resonance circuit;
current detecting means for detecting a current substantially flowing to the discharge lamp; and
controlling means for feedback-controlling the switching element of the inverter circuit based on the current detected by the current detecting means, preheating the discharge lamp at a voltage at which the discharge lamp is not lit, supplying a higher high-frequency voltage than when preheating to the discharge lamp with the operation frequency lowered when starting at least after termination of a preheating action, and controlling the inverter circuit by the feedback control once every predetermined short cycle so that the current of the discharge lamp becomes a predetermined current value when the current detecting means detects the current substantially flowing to the discharge lamp.

2. The discharge lamp lighting device according to claim 1, wherein feedback control of the switching element of the inverter circuit by the controlling means is carried out in a predetermined short-time cycle in the process at least from termination of preheating action to desired lighting of a discharge lamp, which includes the starting time thereof, and the target value of current after termination of the preheating action is gradually increased, wherein a desired lighting state is brought about by gradually increasing the light quantity of the discharge lamp.

3. The discharge lamp lighting device according to claim 1, wherein feedback control of the switching element of the inverter circuit by the controlling means is carried out in every cycle.

4. The discharge lamp lighting device according to claim 1, wherein the controlling means starts a discharge lamp when the discharge lamp is mounted.

5. The discharge lamp lighting device according to claim 1, wherein the controlling means starts the discharge lamp when a light modulation signal is input by peripheral operation when the discharge lamp is in an unlit state.

6. The discharge lamp lighting device according to claim 5, wherein the controlling means varies the tracking of light quantity of the discharge lamp in accordance with a fluctuation amount in the light modulation signal input by peripheral operation.

7. The discharge lamp lighting device according to claim 6, wherein the controlling means causes the current of the discharge lamp to track up to the target value at a value corresponding to the fluctuation amount where the fluctuation amount of a light modulation signal input by peripheral operation is less than a predetermined value, and causes the current of the discharge lamp to track up to the target value at a predetermined upper limit value where the fluctuation amount of a light modulation signal input by peripheral operation is a predetermined value or more.

8. The discharge lamp lighting device according to claim 1, wherein the inverter circuit is a half-bridge type inverter circuit.

9. The discharge lamp lighting device according to claim 1, wherein the discharge lamp is a fluorescent lamp.
